(19) United States
(12) Patent Application Publication
(10) Pub. No.: US 2009/0188580 A1
(43) Pub. Date: Jul. 30, 2009

(54) INERT GAS LOCK FOR FILLING A CONTAINER WITH BULK MATERIAL

(76) Inventor: Hans-Rudolf HIMMEN, Haimhausen (DE)

Correspondence Address: The BOC Group, Inc., 575 MOUNTAIN AVENUE, MURRAY HILL, NJ, 07974-2082, US

(21) Appl. No.: 12/360,339

(22) Filed: Jan. 27, 2009

(30) Foreign Application Priority Data
Jan. 29, 2008 (DE) 122008006558.7

(51) Int. Cl. B65B 31/06; B65B 1/04; B01J 4/00; F17C 13/00

(52) U.S. Cl. 141/100; 141/5; 141/7; 141/331

(57) ABSTRACT

The invention pertains to a gas lock with a cylindrical base body fixed in the opening of a container that can be filled with bulk material, wherein the cross section of said base body essentially corresponds to the cross section of the opening in the container, with a gas supply and with at least one gas outlet that is fluidically connected to the gas supply. The gas lock features means suitable for sealing the container opening in a nearly gas-tight fashion on the lower end of the cylindrical base body, wherein said means control the quantities of bulk material and gas being introduced into the container and are realized in such a way that a gas flow is formed in the direction of the bulk material flowing into the container. These means may consist, for example, of a sealing cone.

### CROSS REFERENCE TO RELATED APPLICATION

This application claims priority under 35 USC §119 to German Patent Application DE 102008006558.7 filed in the German Patent and Trademark Office on Jan. 29, 2008.

### BACKGROUND OF THE INVENTION

The invention pertains to a gas lock that features a cylindrical base body, a gas supply, at least one gas outlet that is fluidically connected to the gas supply, as well as means suitable for sealing in a gas-tight fashion and at least partially opening the lower opening of the cylindrical base body.

In the chemical industry, it is common practice to utilize containers such as, e.g., reactors and mixers, in which an inert atmosphere needs to be maintained. This is necessary, for example, in order to avoid undesirable oxidation reactions. In this case, the respective process not always makes it possible to completely and durably seal the volume to be inerted. When the container is filled or when additives are introduced, in particular, ambient air may also be drawn into the container with the additives.

It is already known to displace atmospheric oxygen from a container by means of inert gases as a protective measure against oxidations or explosions. For this purpose, a lock with a through-opening (gas lock) is mounted, for example, on the container opening. Inert gas is introduced into the through-opening of the lock such that an inert buffer layer is created. Gas locks of this type are already known from the state of the art.

German Offenlegungsschrift DE 26 13 310 discloses a method and a device for feeding solid products into a reaction container. In this case, the feeding device essentially consists of a funnel with a diffuser-shaped drop tube connected thereto. Nozzles are arranged in the transition area between the funnel and the drop tube and inert gas expansion devices are situated in the funnel. The nozzles and the inert gas expansion devices are arranged in such a way that the jet of at least one nozzle has a component in the direction of the reaction container and the jet of at least one nozzle has an oppositely directed component. The container features a ventilation line with a suction nozzle.

DE 39 14 783 discloses a device for preventing the admission of foreign gases through the filling opening of an inerting reaction container. The gas lock disclosed in this publication consists of a jacket pipe and an inner pipe that form a gap and are arranged on the filling opening. Nozzles acted upon with inert gas are directed into this gap. A deflection baffle situated in front of the outlet cross section of the gap directs the inert gas flow toward the pipe axis. This is intended to create a barrier against the admission of foreign gases.

DE 10 2004 008 395 discloses an inert gas lock, in which an adjustable sealing member is provided that makes it possible to vary the free flow cross section for the gas emerging from the gas outlet. The gas lock disclosed in this publication essentially consists of an annular lock base body that defines a through-opening. The sealing member is realized in the form of an L-shaped ring that can be connected to the lock base body and adjusted relative thereto. The vertical limb of the L-shaped ring is positioned on the outside of the lock base body while its horizontal limb is situated underneath the lock base body. The horizontal limb is pulled so far in the direction of the lock axis that the outlet openings situated on the underside of the lock base body are covered. The L-shaped ring deflects gas emerging from the outlet openings radially inward in the direction of the through-opening, wherein the emerging quantity of gas can be influenced by increasing or decreasing the size of the gap between the ring and the lock base body.

DE 10 2004 008 395 furthermore discloses a second embodiment of a gas lock. In this embodiment, the gas is supplied via two cones that are arranged on one another in the center of the through-opening. In this context, the term center refers to an area that covers no more than 30% of the through-opening area. In this embodiment of the invention, the gas quantity can also be adjusted by varying the gap between the two cones.

In conventional gas locks known from the state of the art, the inert gas is essentially introduced horizontally into the through-opening for the bulk material. The largest portion of the area of the through-opening in gas locks according to the state of the art is kept open for the bulk material. Neither of the described gas locks features means for sealing the through-opening for the bulk material or a control for the quantity of bulk material introduced into the container per time unit. The inerting of the container is essentially maintained with an inert gas barrier layer in the passage of the lock. The bulk material also needs to pass this inert gas barrier layer such that turbulences are created therein and its function is impaired.

### SUMMARY OF THE INVENTION

The present invention consequently is based on the objective of realizing a gas lock in such a way that the gas lock can be sealed in a gas-tight fashion and an inert gas flow is formed in the direction of the bulk material passing the lock.

The objective at hand is attained in that the means for opening and sealing the cylindrical base body contain the fluidic connection between the gas supply and the gas outlet.

The gas lock features means for sealing the lower end of the cylindrical base body in a gas-tight fashion. This makes it possible to largely inert the volume of the gas lock before it is filled with bulk material, namely while the container remains sealed. Since the means for opening and sealing the cylindrical base body contain the fluidic connection between the gas supply and the gas outlet, the bulk material is introduced into the container together with the inert gas when the lock is open.

The means for sealing the cylindrical base body are realized in such a way that the bulk material, as well as the inert gas, is introduced or flows into the container along these means. The sealing means may also serve for controlling the quantity of inert gas and the quantity of bulk material being introduced into the container.

Due to the simultaneous and parallel introduction of the inert gas and the bulk material into the container, the maintenance of the container inerting is significantly improved. Rather than creating an inert gas barrier layer, an inert gas flow into the container is established. Consequently, there is no inert gas barrier layer that is subjected to turbulences by bulk material flowing into the container, but the inert gas atmosphere in the container is instead improved by inert gas flowing into the container together with the bulk material. Due to the means for sealing in a gas-tight fashion and opening the cylindrical base body, the inventive gas lock is particularly suitable for use in containers, in which the frequency of the filling processes fluctuates. In this case, the diameter of the cylindrical base body corresponds to the diameter of the opening in the container to be filled.

It is advantageous to place a conical member in the form of an envelope of a truncated cone on the cylindrical base body. Due to the combination of the cylindrical base body with a conical member, a funnel is created that can be easily filled with all types of bulk material.

According to one preferred embodiment of the invention, the means for opening and sealing the cylindrical base body feature a cone or truncated cone, the diameter of which is at least identical to that of the cylindrical base body, a nozzle tube and a spring, wherein the nozzle tube is connected to the cone or truncated cone and forms the fluidic connection between the gas supply and the gas outlet. The spring is preferably connected to the upper edge of the cylindrical base body or the upper edge of the conical member.

In this embodiment of the invention, the cylindrical base body is sealed by a cone or truncated cone (also referred to as sealing cone) on the lower end. The cone or truncated cone is fixed on the upper edge of the cylindrical base body or on the upper edge of the conical member by means of a nozzle tube and a spring. In its prestressed state, the spring positions the cone or truncated cone exactly on the lower end of the cylindrical base body. Since the cone or truncated cone has a base of at least the size of the cylindrical base body, no gap can be formed between the cone or truncated cone and the cylindrical base body. The container therefore is sealed in a nearly gas-tight fashion.

In order to fill the container, the sealing cone is pressed downward manually, pneumatically or electrically such that a gap is created between the cylindrical base body and the sealing cone. The bulk material is introduced into the container through this gap together with the inert gas flowing along the sealing cone. Due to the design of the means for sealing the gas lock in the form of a cone, only an annular gap is formed between the sealing cone and the cylindrical base body. In this case, the inert gas and the bulk material are jointly introduced into the container interior by the envelope of the sealing cone. In this embodiment of the invention, the quantity of bulk material and the quantity of inert gas flowing into the container can be controlled by varying the size of the annular gap. Accordingly, the prestressed spring causes the sealing cone to automatically reseal the container after the cylindrical base body has been emptied.

For the continuous filling of the container, a permanent gap is adjusted between the cone or truncated cone and the cylindrical base body. This is achieved by blocking the spring or the sealing member, for example, by means of a spacer that is clamped into the annular gap.

The nozzle tube advantageously features a widening on the lower end. The widening is advantageously positioned exactly above the point of the sealing cone. The widening ensures a uniform radial distribution of the inert gas and directs the emerging gas downward along the envelope surface of the cone or truncated cone. Due to this design, the inert gas simultaneously flows in the same direction as the bulk material and is introduced into the container together with the bulk material. In this case, the means for controlling the emerging quantity of gas may consist, for example, of washers that define the height of a gap between the conical outlet of the nozzle and the cone or truncated cone. Due to the combination of the widening of the nozzle tube and the cone, a 360° fan nozzle is created that ensures a gas flow along the cone envelope.

In another preferred embodiment of the invention, the means for opening and sealing the cylindrical base body feature two surfaces with a common center that can be turned relative to one another and means for turning at least one surface, wherein the surfaces that can be turned relative to one another have at least the same diameter as the cylindrical base body and feature recesses that are arranged such that the overlap between the recesses is adjusted between no overlap and a complete overlap when the surfaces are turned relative to one another.

The means for turning the surfaces advantageously consist of an inner pipe and a jacket pipe, wherein the inner pipe is connected to one of the surfaces and the jacket pipe forms the fluidic connection between the gas supply and the gas outlet.

The recesses preferably have the shape of a sector of a circle that is defined by two radial lines and an arc.

The gas-tight seal and the opening of the cylindrical base body are respectively realized by turning two surfaces that feature recesses. The surfaces have a common center and are situated on the lower end of the cylindrical base body of the gas lock. A maximum overlap or a zero overlap of the recesses can be adjusted by turning one or both surfaces. Once the overlap of the recesses is adjusted, openings are formed between the container and the gas lock and the bulk material is introduced into the container through these openings. The container is sealed in a nearly gas-tight fashion when no overlap between the recesses is adjusted. In the simplest and preferred embodiment, both surfaces are realized circularly in accordance with the cross section of the cylindrical base body and feature recesses in the form of sectors of a circle (pie slices). These recesses can be arranged congruently or incongruently by simply turning one surface. The surface is turned, for example, by fixing a rod assembly on the inner pipe above the base body or the conical member.

It is particularly preferred that the upper surface consists of a profiled surface, wherein the connecting line from the center of the surface to the center of the arc of a non-recessed sector of a circle is respectively elevated relative to the two radial lines that define the non-recessed sector of a circle. In this embodiment of the invention, the center of a non-recessed sector of a circle is elevated such that such that the bulk material cannot accumulate on the non-recessed sector of a circle, but rather automatically slides toward the recesses on the inclined surfaces due to the gravitational force. It is particularly preferred that the elevation of the connecting line from the center of the surface to the center of the arc of a non-recessed sector of a circle increases with the distance from the center.

In one preferred embodiment of the invention, the gas outlet is situated directly above the center of the upper rotatable surface. Due to this design of the gas outlet, the inert gas is radially distributed in a uniform fashion and directed downward in the filling direction. The gas supply is realized with the aid of the jacket pipe that surrounds the inner pipe for turning the surface. The means for controlling the gas quantity consist, for example, of a disk that is positioned on the inner pipe such that a gap is formed between the disk and the jacket pipe. The gas is discharged into the gas lock through this gap. The gas quantity can be varied by adjusting the size of the gap.

In another preferred embodiment of the invention, the jacket pipe is connected to at least two radial distribution pipes, wherein the distribution pipes feature at least two gas outlet openings on the underside. The distribution pipes preferably have a triangular profile and are oriented in such a way that one corner is situated above the other two corners. The distribution pipes for the gas outlet are advantageously positioned above the elevated connecting lines between the center of the surface and the center of the arc of a non-recessed sector of a circle. The distribution pipes may have a round or triangular profile. The triangular profile ensures an improved and uniform gas discharge along the two inclined surfaces of a non-recessed sector of a circle. Consequently, the inert gas also flows in the same direction as the bulk material in this embodiment of the invention.

In a few applications, it proved practical to provide the annular gap that automatically results between the cylindrical base body of the gas lock and the container opening with means for supplying or discharging gas rather than completely closing this annular gap. This embodiment of the invention makes it possible to realize a simple control of the container atmosphere. Depending on the respective requirements, additional inert gas can be introduced into the container or excess pressure of the container can be relieved.

The present invention primarily describes gas locks for circular container openings. However, its principle can be adapted to arbitrarily shaped container openings by a person skilled in the art. In case of a rectangular container opening, for example, the gas lock would also feature a cuboid base body and the cone or truncated cone would be realized in the form of a pyramid with rectangular base. The inventive gas lock is suitable for all gases known to a person skilled in the art, e.g., nitrogen, argon, carbon dioxide or similar gases that are adapted to the respective application.

The present invention makes it possible, in particular, to realize a gas lock for a bulk material container that can be easily operated. Due to the sealing and opening means on the lower end of the cylindrical base body, the gas lock can be permanently attached to the container. The container can be continuously or discontinuously filled within arbitrary intervals in a nearly unproblematic fashion. An inert gas flow in the direction of the container is established on the lower end of the cylindrical base body. Due to the simultaneous introduction of the inert gas and the bulk material into the container, the maintenance of the container inerting is significantly improved.

### BRIEF DESCRIPTION OF THE DRAWINGS

The invention is described in greater detail below with reference to two embodiments that are illustrated in the drawings.

In these drawings,

FIG. 1 shows an embodiment of the invention with a sealing cone.

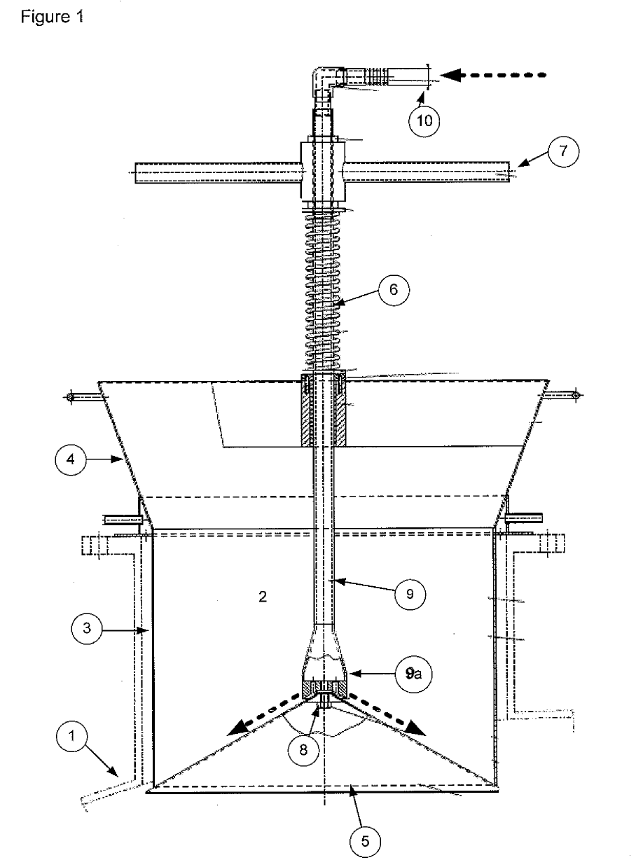

FIG. 2A shows a sideview embodiment of the invention with rotatable surfaces for sealing the gas lock, while FIG. 2B shows the top view embodiment.

### DETAILED DESCRIPTION OF THE INVENTION

The gas lock (2) is inserted and screwed into the opening of the container (1). Alternatively, the gas lock (2) may also be mounted by means of a clamping device. The gas lock consists of a cylindrical base body (3) and a conical member (4) arranged thereon. A sealing cone (5) is situated on the lower end of the cylindrical base body. The sealing cone is connected to the upper edge of the conical member by means of a nozzle tube (9). This connection can be produced, for example, with three radial braces that are welded to the upper edge of the conical member (4). The gas outlet (8) is widened (9a) on the lower end of the nozzle tube (9) and situated exactly above the point of the sealing cone. The prestressed spring (6) pulls the sealing cone (5) upward such that the gas lock (2) is sealed in a nearly gas-tight fashion. The sealing cone (5) can be pressed downward with the aid of a handle (7). During the discontinuous filling of the container (1), the funnel consisting of the cylindrical base body (3) and the conical member (4) is filled with bulk material. Inert gas is simultaneously introduced into the funnel via the gas supply (10) and the gas outlet (8). The container (1) is still sealed in a nearly gas-tight fashion by the sealing cone (5), wherein the sealing cone (5) has a larger base than the cylindrical base body (3) in this embodiment. The sealing cone (5) moves downward when the handle (7) is actuated. This creates an annular gap between the sealing cone (5) and the cylindrical base body (3). The bulk material is introduced into the interior of the container through this gap together with the inert gas flowing along the envelope surface of the sealing cone (3). The inert gas flow is symbolized with arrows that are drawn with broken lines. After emptying the funnel (3, 4), the spring once again automatically pulls the sealing cone against the lower end of the cylindrical base body (3) such that the annular gap between the sealing cone (5) and the cylindrical base body (3) is closed and the container is sealed in a gas-tight fashion. The next filling cycle can now begin. In order to realize a continuous filling process, it is merely required to respectively set or wedge spacers, for example, in the form of blocks of wood between the lower edge of the cylindrical base body (2) and the sealing cone (5).

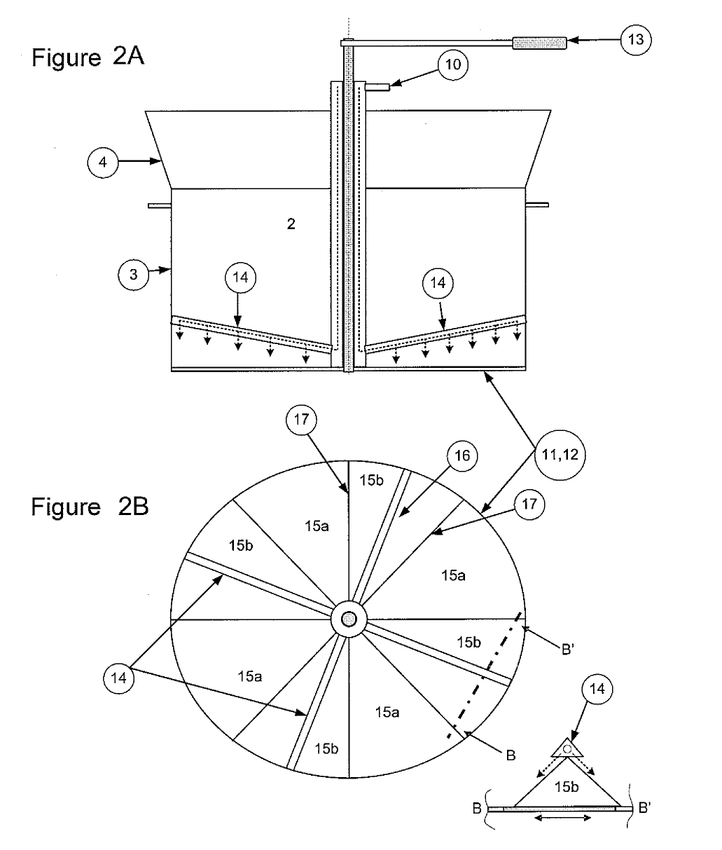

FIG. 2 shows another embodiment of the invention in the form of a side view (2A) and a top view (2B). In this case, two rotatable surfaces (11, 12) with a common center are situated on the lower end of the cylindrical base body (3) and seal the gas lock (2) in a gas-tight fashion. Both surfaces (11, 12) respectively feature recesses (15a) that have the shape of a sector of a circle. These recesses can be arranged congruently or incongruently by turning the two surfaces with the aid of the handle (13) and the inner pipe (18b). During the filling of the container, the funnel (3, 4) is filled with bulk material and gas is simultaneously introduced into the funnel (3, 4) via the gas supply (10). The gas is discharged into the funnel by four radial distribution pipes (14). The distribution pipes are fluidically connected to the jacket pipe (18a). The two surfaces are turned by means of the handle (13) and the inner pipe (18b) such that the recesses of the two surfaces (15a) overlap. The non-recessed sectors of a circle (15b) feature a profile. The connecting line (16) between the center of the surface and the center of the non-recessed sector of a circle (15b) is elevated relative to the two radial lines (17) that define the sector of a circle. This elevation increases with the distance from the center. The four radial distribution pipes (14) for the inert gas respectively extend along the connecting line (16) between the center of the surface and the center of the arc. The distribution pipes (14) have a triangular profile such that the inert gas uniformly flows along both lateral surfaces of the sector of a circle (15b). The profile of the segments of a circle (15b) ensures a troublefree transport of the bulk material into the container (1). After emptying the funnel (3, 4), the gas lock (2) can be once again sealed in a nearly gas-tight fashion by turning the handle (13). This embodiment of the invention is particularly suitable for lengthy continuous filling processes.

1. A gas lock that features a cylindrical base body, a gas supply, at least one gas outlet that is fluidically connected to the gas supply, as well as means suitable for sealing in a gas-tight fashion and at least partially opening the lower opening of the cylindrical base body, characterized in that the means for opening and sealing the cylindrical base body contain the fluidic connection between the gas supply and the gas outlet.

2. The gas lock according to claim 1, characterized in that a conical member in the form of an envelope of a truncated cone is placed on the cylindrical base body.

3. The gas lock according to claim 1, characterized in that the means for opening and sealing the cylindrical base body feature a cone or truncated cone, the diameter of which is at least identical to that of the cylindrical base body, a nozzle tube and a spring, wherein the nozzle tube is connected to the cone or truncated cone and forms the fluidic connection between the gas supply and the gas outlet.

4. The gas lock according to claim 3, characterized in that the spring is connected to the upper edge of the cylindrical base body or the upper edge of the conical member.

5. The gas lock according to claim 3, characterized in that the nozzle tube features a widening on the lower end.

6. The gas lock according to claim 1, characterized in that the means for opening and sealing the cylindrical base body feature two surfaces with a common center that can be turned relative to one another and means for turning at least one surface, wherein the surfaces that can be turned relative to one another have at least the same diameter as the cylindrical base body and feature recesses that are arranged such that the overlap between the recesses is adjusted between no overlap and a complete overlap when the surfaces are turned relative to one another.

7. The gas lock according to claim 6, characterized in that the means for turning the surfaces consist of an inner pipe and a jacket pipe, wherein the inner pipe is connected to one of the surfaces and the jacket pipe forms the fluidic connection between the gas supply and the gas outlet.

8. The gas lock according to claim 7, characterized in that the recesses have the shape of sectors of a circle that are defined by two radial lines and an arc.

9. The gas lock according to claim 8, characterized in that the upper surface consists of a profiled surface, wherein the connecting line from the center of the surface to the center of the arc of a non-recessed sector of a circle is respectively elevated relative to the two radial lines that define the non-recessed sector of a circle.

10. The gas lock according to claim 6, characterized in that the gas outlet is situated directly above the center of the upper circular surface.

11. The gas lock according to claim 6, characterized in that the jacket pipe is connected to at least two radial distribution pipes, wherein the distribution pipes contain at least two gas passage openings on the underside.

12. The gas lock according to claim 11, characterized in that the distribution pipes have a triangular profile.
